(19) United States
(12) Patent Application Publication
(10) Pub. No.: US 2026/0298805 A1
(43) Pub. Date: Oct. 1, 2026

(54) SYSTEMS AND METHODS FOR DETERMINING CONCENTRATIONS USING ABSORBANCE CHANGE WITH TEMPERATURE

(71) Applicant: Kaitao Lu, Irvine, CA (US)

(72) Inventor: Kaitao Lu, Irvine, CA (US)

(21) Appl. No.: 19/478,603

(22) PCT Filed: Apr. 25, 2024
(86) PCT No.: PCT/US2024/026342

§ 371 Date: Oct. 24, 2025

Related U.S. Application Data
(60) Provisional application No. 63/498,603, filed on Apr. 27, 2023.

(51) Int. Cl. G01N 21/19; G01N 1/44; G01N 21/21

(52) U.S. Cl. CPC G01N 21/19; G01N 1/44; G01N 21/21

(57) ABSTRACT

A method for measuring the concentration of ortho-phthalaldehyde (OPA) in a sample is provided. The method involves the use of a spectrophotometer to measure the absorbance of OPA at a specific wavelength, and the use of a standard curve to convert the change in absorbance value with temperature (slope) to a concentration value. The method is specific (selective), simple, rapid, and highly accurate, making it suitable for use in a variety of applications, such as the monitoring of OPA concentrations in disinfection/sterilization industrial settings.

### CROSS REFERENCE TO RELATED APPLICATIONS

The present application claims priority to U.S. Provisional Application No. 63/498,603, filed on Apr. 27, 2023, which is incorporated by reference in its entirety.

### BACKGROUND

### Field of the Disclosure

This disclosure relates to quantitative analytical methods for measuring unknown concentrations of chemicals. In particular, this disclosure relates to determining the concentration of solutes and solvents with large variations in absorbance over a moderate temperature range.

### Description of Related Art

Beer's law (sometimes called the Beer-Lambert law) states that the absorbance of a sample is proportional to the path length, b, through the sample and the concentration of the absorbing species, c:

$$α ∝ b * c \qquad ( 1 )$$

More formally, the proportionality constant is represented by & and is called the extinction coefficient:

$$A = ε * b * c \qquad ( 2 )$$

If ε has molar units, it is called the molar extinction coefficient, or the molar absorptivity. The molar absorptivity of most compounds varies with wavelength, and Beer's law is more accurately written as a function of λ:

$$A ( λ ) = ε ( λ ) * b * c \qquad ( 3 )$$

Most substances follow Beer's law at low to moderate concentrations of absorbing species and begin to deviate due to saturation effects at high concentrations. The absorbance of any particular compound can, for example, vary over wavelength, but also depend on the refractive index of a solvent, and depend on solute-solvent interactions. However, once within a particular solvent most substances will conserve their absorbance at any particular wavelength. This is due in part to the quantum mechanical properties of light absorption that are encapsulated in the Thomas-Reiche-Kuhn (TRK) sum rule, which mandates that the integrated (electronic) oscillator strength of an absorber equals the total number of electrons in the structure. As the total number of electrons in a substance will be conserved absent a chemical reaction, so will the total integrated absorbance be conserved over all wavelengths. Typical molecular chromophores may place only about 1% of their oscillator strength in the UV-vis window, so individual chromophores operate at about 1% of their theoretical limit. Accordingly, the absorbance of some chromophores may be sensitive to chemical/physical changes and redistribute the ~1% of their oscillator strength within the UV-vis window, by for example, strengthening a transition, shifting an absorbance peak to a different wavelength, and/or widening the full width half max of the absorbance peak.

For some compounds, absorbance can change with conditions such as pH and temperature. For pH, the absorption change can be due to changes in the conjugation of electron orbitals in the molecule caused by the addition/removal of a proton to the molecule. A variety of effects can contribute to the change of absorption at a particular wavelength, including conformational changes to the molecule, changes to the solvation of the molecule, and broadening of the absorption linewidth. This temperature-dependent-absorbance feature is usually very small and normally creates inaccuracy and inconstancy when measuring absorbance because a sample's temperature under ambient conditions is not always constant. The direct relationship between absorbance and concentration illustrated by Beer's law, above, and reliable absorption coefficients often makes absorbance a more useful mode for spectra than, for example, transmittance or fluorescence.

UV-Vis spectrophotometry has been widely used for qualitative and quantitative analyses due to its accuracy, simplicity and low cost. However, generally this technique's selectivity or specificity is challenged when measuring ingredients in a mixture, especially with degradation products as impurities that may overlap at relevant wavelengths. Many absorption features of organic molecules will overlap in the ultraviolet or infrared regions, which confounds the individual determination of the concentration of separate compounds in a mixture. Accordingly, not all compounds are immediately amenable to concentration determination using absorbance with standard techniques, such as measuring at a single temperature. Other methods, such as High-performance liquid chromatography (HPLC) and chemical titration methods are only available in a laboratory and may be time consuming. Although semiquantitative test strips are available, these do not provide a quantitative result.

O-Phthalaldehyde (OPA) solution is a high-level disinfection liquid for scoping, dialysis, breathing, and anesthesia equipment. It is important to accurately measure the concentration of OPA in order to ensure proper efficacy and safety. OPA should have a concentration higher than 0.3% to be efficacious. If the concentration of the disinfectant solution drops below this requirement, the solution would be discarded.

Current methods used to measure OPA may include relatively high levels of operational complexity and/or comparatively low levels of accuracy. These methods may be expensive and/or not convenient for continuous monitoring during a typical disinfecting process. There exists a need for quantitative test systems and methodologies that can accurately determine the concentration of compounds through spectrophotometry, in light of the challenges listed above.

### SUMMARY OF THE DISCLOSURE

A device according to this disclosure may include a spectrophotometric system, a sample heater, and a temperature monitor. Software may process the absorbance-temperature data and automatically create the slope and concentration. The device may be a stand-alone instrument or assembled into an automatic disinfection/sterilization system that uses OPA solutions.

Embodiments of the present disclosure may include a system for measuring a concentration of a chemical in a sample, the system including a spectrophotometric system including a light source, a sample cell for containing the sample, and a light detector. Embodiments may also include a heating element for heating the sample cell. Embodiments may also include a temperature probe. Embodiments may also include a processor configured to determine the concentration of the chemical by determining a slope of an absorbance-temperature curve of the sample and comparing the slope with a standard slope-concentration relationship of the chemical. Embodiments may determine the concentration of a compound with a temperature dependent absorbance. Embodiments may determine the concentration of a compound in a solution, where the solution has a temperature dependent absorbance, and the chemical does not. For example, if one of the solvents or components of a solution has a temperature dependent absorbance that overlaps with the temperature-independent absorbance of an analyte, the concentration of the solvent may be measured and the contribution of the solvent to the overlapping absorbance can be deduced. Accordingly, the disclosed methods may be applied to deduce the contributions to absorption of analytes from previously overlapping spectra.

In some embodiments, the chemical may be selected from a molecule with an absorbance that changes with temperature. In some embodiments, the chemical may be selected from a conjugated molecule with labile protons, and a solvated molecule. In some embodiments, the chemical may be selected from Ortho-Phthalaldehyde (OPA), substituted and unsubstituted benzene, glucose, and proteins. Substituted benzene may comprise substituted or unsubstituted toluene. Substituted toluene may comprise substituted and unsubstituted o-, m-, p-xylenes.

Unless defined otherwise, all technical and scientific terms used herein have the same meaning as is commonly understood by one of ordinary skill in the art.

When a group is described as being “unsubstituted or substituted,” if substituted, the substituent(s) may be selected from one or more of the indicated substituents. If no substituents are indicated, it is meant that the indicated “optionally substituted” or “substituted” group may be substituted with one or more group(s) individually and independently selected from H, alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, mercapto, alkylthio, arylthio, cyano, halogen, thiol, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfinyl, sulfonyl, haloalkyl, haloalkoxy, trihalomethanesulfonyl, trihalomethanesulfonamido, an amino, a mono-substituted amino and a di-substituted amino group.

In some embodiments, the system has an accuracy of at least plus/minus 0.1 w %, 0.09 w %, 0.08 w %, 0.07 w %, 0.06 w %, 0.05 w %, 0.04 w %, 0.03 w %, 0.02 w %, 0.01 w %, or 0.005%. In some embodiments, the system has an accuracy of at least plus/minus 0.1 w % for OPA concentrations near minimum efficacious concentration of approximately 0.3 w %. In some embodiments, the system has an accuracy of plus/minus 0.05 w % for OPA concentrations near minimum efficacious concentration of approximately 0.3 w %. In some embodiments, the system has an accuracy of plus/minus 0.01 w % for OPA concentrations near minimum efficacious concentration of approximately 0.3 w %.

In some embodiments, an absorbance may be measured at a wavelength in the range of about 190 to about 1100 nm. In some embodiments, a measured wavelength may be greater than 800 nm. In some embodiments, the absorbance may be measured at a wavelength in the range of about 200 to about 700 nm. In some embodiments, the absorbance may be measured at a wavelength in the range of about 200 to about 600 nm. In some embodiments, the absorbance may be measured at a wavelength in the range of about 230 to about 380 nm. In some embodiments, the absorbance may be measured at a wavelength in the range of about 300 to about 400 nm. In some embodiments, the absorbance may be measured at a wavelength in the range of about 330 to about 400 nm. In some embodiments, the absorbance may be measured at a wavelength around 350 nm. In some embodiments, the absorbance may be measured at a wavelength around 340 nm. In some embodiments, the absorbance may be measured at a wavelength around 342 nm.

In some embodiments, the absorbance may be measured at a wavelength corresponding to a maximum absorbance feature. In some embodiments, the absorbance may be measured at a wavelength that does not correspond to a maximum absorbance feature. In some embodiments, wavelengths near a peak of an absorbance feature may saturate the detector, and other wavelengths may be preferable. Accordingly, in some embodiments a sample may be diluted, measured in a thinner pathlength cuvette, and/or measured at a different wavelength so as to measure an absorbance less than at least one of 5, 4, 3, 2, 1.5, 1.2, 1.1, 1.0, 0.95, 0.9, 0.85, 0.8, 0.75, 0.7, 0.6, 0.5, 0.4, or 0.3 a.u.

In some embodiments, the temperature probe may be a thermal couple or spectroscopic probe of temperature. In some embodiments, the temperature probe may be an infra-red (IR) probe. In some embodiments, the heating element may include at least one of an electrical heating element, and a microwave.

In some embodiments, the heater may be not operably connected to the spectrophotometric system. In some embodiments, the system may include a reservoir. In some embodiments, the sample may be recycled to the reservoir during or after the measurement. In some embodiments, the first temperature may be elevated compared to the second temperature. In some embodiments, the second temperature may be closer to the room temperature and may be achieved by passively cooling from the first temperature.

In some embodiments, the light detector may include at least one of a photomultiplier tube (PMT), a single channel light sensor, and a light detector comprised within a spectrophotometer system. In some embodiments, the method may include heating the sample to the first temperature and letting the sample cool to the second temperature. In some embodiments, a standard slope-concentration curve for a chemical may be established by determining the absorbance-temperature relationship of a chemical standard at one or more known concentrations (single- or multi-point calibration, based on measuring a linear relationship between the concentration of the analyte and its absorbance). A single-point concentration calibration is a simplified method that uses one known concentration in analytical chemistry for determining the concentration of an analyte in a sample. A multi-point concentration calibration uses more than one known concentrations for determining the concentration of an analyte in a sample, which may provide evaluation of linearity of the calibration. This method involves measuring the absorbance-temperature slope of standard solution(s) of known concentration and using the measurement(s) as a reference point(s) to infer the concentration of the analyte in unknown samples. In some embodiments, a single point calibration may be used, where, for example, a sample with a known concentration of an analyte is measured at multiple temperatures to determine an absorbance-temperature relationship of the analyte at known concentration. The absorbance-temperature relationship may have units that are proportional to the change in absorbance per unit temperature per unit

$$\frac{Δ ABS a . u .}{Temp . °C \times Conc . M} .$$

With a known absorbance-temperature-concentration relationship, the concentration of an analyte can be determined.

In some embodiments, the chemical may be Ortho-Phthalaldehyde (OPA), shown below. In some embodiments, the system may include at least one filter for measuring circular dichroism. In some embodiments, the system may include at least one filter for measuring polarization. In some embodiments, the system may include filters for measuring circular dichroism and for measuring polarization. In some embodiments, the system may be a self-contained and portable device, that measures absorbance from a single channel light sensor.

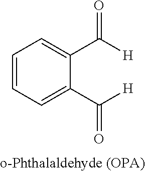

Embodiments of the present disclosure may also include an analytical method for measuring a concentration of a chemical in a sample, the method including the steps of measuring a first absorbance of the sample at a first temperature. Embodiments may also include measuring a second absorbance of the sample at a second temperature. Embodiments may also include determining a measured slope of absorbance-temperature relationship of the sample. Embodiments may also include determining a measured concentration of the chemical by correlating the measured slope with a standard slope-concentration curve for the chemical. In some embodiments, the method has an accuracy of at least plus/minus 0.1 w %, 0.09 w %, 0.08 w %, 0.07 w %, 0.06 w %, 0.05 w %, 0.04 w %, 0.03 w %, 0.02 w %, or 0.01 w %. In some embodiments, the method has an accuracy of plus/minus 0.01 w % for OPA concentrations near minimum efficacious concentration of approximately 0.3 w %.

Embodiments of the present disclosure may also include a processor for measuring a concentration of a chemical in a sample, the processor configured to determine a first absorbance of the sample at a first temperature. In some embodiments, information on the absorbance-temperature relationship of the chemical may also be provided. In some embodiments, determining the concentration of the chemical in the sample may be performed by correlating the first absorbance with the information on the absorbance-temperature relationship of the chemical. In some embodiments, the information on the absorbance-temperature relationship of the chemical may include at least one of a second absorbance of the sample at a second temperature. Some embodiments may also include a measured slope of absorbance-temperature relationship of the sample.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 illustrates an example spectrophotometric system which may be used to implement some embodiments of the disclosed technology.

FIG. 2 illustrates a flow chart of the operations used in some embodiments of the disclosed technology.

FIG. 3 illustrates example absorption spectra of one of the disclosed compounds.

FIG. 4A, B illustrate example absorption spectra of one of the disclosed compounds over a range of temperatures and wavelengths.

FIG. 5 shows six graphs of the change in absorption at 342 nm over a range of temperatures for one of the disclosed compounds.

FIG. 6 shows a graph of the linear relationship between concentration and the slope of the change in absorption per unit temperature.

FIG. 7 shows a graph of the linear relationship between concentration and the slope of the change in absorption per unit temperature for a standard stock solution #2.

FIG. 8 shows a graph of the linear relationship between concentration and the slope of the change in absorption per unit temperature for standard stock solutions #1 and #2.

FIG. 9 shows a graph of the linear relationship between concentration and the slope of the change in absorption per unit temperature for Metricide OPA Plus solution.

FIG. 10 shows a graph of the linear relationship between concentration and the slope of the change in absorption per unit temperature for solutions from 0.03% to 0.1% of OPA.

FIG. 11 shows a graph of the linear relationship between concentration and the slope of the change in absorption per unit temperature for solutions from 0.002% to 0.008% of OPA.

### DETAILED DESCRIPTION

The following description and examples illustrate an embodiment of the present disclosure in detail. Those of skill in the art will recognize that there are numerous variations and modifications of this disclosure that are encompassed by its scope. Accordingly, the description of a preferred embodiment should not be deemed to limit the scope of the present disclosure.

The illustrative embodiments described in the detailed description, drawings, and claims are not meant to be limiting. The teachings herein can be applied in a multitude of different ways, including for example, as defined and covered by the claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspect and that two or more of these aspects may be combined in various ways. For example, a system or apparatus may be implemented or a method may be practiced by one of skill in the art using any reasonable number or combination of the aspects set forth herein. In addition, such a system or apparatus may be implemented or such a method may be practiced using other structure, functionality, or structure and functionality in addition to or other than one or more of the aspects set forth herein. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure. It is to be understood that the disclosed embodiments are not limited to the examples described below, as other embodiments may fall within disclosure and the claims.

This disclosure reports the surprising observation of a large monotonic variation in absorbance for a series of compounds. In some embodiments, a large monotonic variation may be about a 50% change in absorbance, about a 20% change in absorbance, about a 10% change in absorbance and about a 5% change in absorbance. For these compounds, the absorbance changes with temperature, and the absorbance change rate may be measured. The temperature may be varied over about 20° C. to about 70° C. The temperature may be varied over about 30° C. to about 60° C. The temperature may be varied over about 40° C. to about 50° C. The disclosure provides the novel observation that the absorbance-temperature relation was linear over the disclosed temperature ranges, and a repeatable slope may be obtained for a solution. Further tests demonstrate that a slope-concentration relationship was also linear. Based on these unexpected findings, a test method with a spectrophotometry technology combined with temperature measurement has been developed and is disclosed herein.

This disclosure provides for the first report that quantitative concentration measurements may be performed using absorbance temperature variations over certain concentration, temperature and wavelength ranges. In some embodiments, concentration measurements may be performed over relevant concentrations, such as between about 0.01 wt % and about 10 wt %, between about 0.1 wt % and about 1 wt %, or between about 0.05 wt % and about 0.75 wt %. In some embodiments, concentration measurements may be performed over relevant concentrations, such as between about 0.01 mM and about 10 M, between about 0.1 mM and about 1 M, or between about 0.05 mM and about 0.75 M. In some embodiments, concentration measurements may be performed over relevant concentrations, such as between concentrations resulting in about 0.001 a.u and about 10 a.u., between about 0.01 a.u. and about 1 a.u., or between about 0.05 a.u. and about 0.75 a.u. In some embodiments, concentration measurements may be performed over temperature ranges, such as about −10° C. to about 120° C., about 0° C. to about 100° C., about 10° C. to about 90° C. and about 20° C. to about 80° C. In some embodiments, concentration measurements may be performed over moderate temperature ranges, such as about 20° C. to about 40° C. In some embodiments, concentration measurements may be performed over wavelength ranges that are measurable by UV-vis spectrometers. In some embodiments, the measurements may be performed over a wavelength range, such as about 100 nm to about 1000 nm, such as about 150 nm to about 900 nm, such as about 200 nm to about 800 nm, such as about 200 nm to about 750 nm, or such as about 200 nm to about 400 nm. In some embodiments, the measurements may be performed at a single wavelength (or a small window of wavelengths) within a range from about 100 nm to about 1000 nm. In some embodiments, the measurements may be performed at a single wavelength, such as about 200 nm, or other wavelengths including about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, about 780 nm, about 790 nm, about 800 nm, about 810 nm, about 820 nm, about 830 nm, about 840 nm, about 850 nm, about 860 nm, about 870 nm, about 880 nm, about 890 nm, or about 900 nm.

No other known disclosure has recognized that the changes in absorbance as a function of temperature may be used to quantitatively determine concentrations of certain compounds. Furthermore, no other known report has recognized that such techniques may be used to quantitatively determine concentrations of a particular compound within a solution that may include overlapping absorbers. In some embodiments, the disclosure provides for measuring the concentration of a selected compound in a solution containing a mixture of compounds. For example, the disclosure provides for methods that may measure the concentration of an analyte, such as OPA, even where an impurity had an overlapping absorbance feature with OPA, because OPA will change absorbance with temperature and the impurity would not. Accordingly, any measured changes in absorbance at different temperatures could be ascribed to OPA and not the impurity, and so the concentration of OPA in the sample could be calculated from the observed change in absorbance.

Once a quantitative relation between the change rate (change in absorbance (a.u.) per degree Celsius) and the compound's concentration (in molarity or wt %) is established, the unknown concentration of sample may be determined by measuring the absorbance change rate over a controlled range of temperature. The large variation in absorption over temperature was not observed to the same degree, or at all, from the solvent or other compounds in the mixture, and so the absorbance change rate can be attributed predominantly or solely to the compound of interest. Advantageously, this change in absorption versus temperature relationship can be used even if there are overlapping absorption features from different ingredients in the mixture. Note that even if two compounds had a temperature dependent absorption property, there is only a low probability that these compounds would both change absorbance at the same wavelengths and in the same magnitude, so as to make the measurement of the concentrations difficult. As the temperature change may be conveniently controlled and measured while the composition of the sample is conserved, a quantitative test methodology is disclosed herein.

The disclosed systems and methods demonstrate favorable precision (repeatability and reproducibility), linearity, specificity (selectivity), accuracy and robustness. This disclosure reports the positive feasibility of selectively testing for OPA concentration by measuring absorbance change with temperature for a sample containing OPA.

This disclosure includes several advantageous findings and reports the observation that absorbance-temperature (A-T) relation is linear in controlled temperature ranges and a slope (referred to as “k” throughout) can be determined for an arbitrary OPA solution. The slope of an OPA solution is repeatable in multiple replicates and reproducible among multiple days. The relation of the slope with OPA concentration is linear and proportional, and the quantitative relation may be established with known (standard) OPA concentrations, prior to or concurrently with each experiment. A major degradation product 2-carboxybenzaldehyde (CBA) does not considerably impact the test, which demonstrates the selectivity against a relevant impurity. Therefore, the OPA concentration of a sample may be selectively determined by measuring the A-T slope K. The method is advantageously applied to Cidex® OPA and MetriCide™ OPA Plus solutions, which are two different OPA formulations.

The present disclosure has numerous applications, including monitoring of OPA concentrations in pharmaceutical and medical settings. The disclosure provides for the rapid and accurate measurement of OPA concentrations in disinfectant and sterilizing solutions, ensuring proper efficacy and safety. The present disclosure also provides for quality control in industrial settings: The disclosure may be applied to quality control purposes in industries that use OPA, such as the production of pharmaceuticals and medical devices.

The disclosed methods are compatible with, and may include additional analytical chemistry techniques, such as standard addition or internal standards to remove matrix effects.

### Definitions

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

All references cited herein are incorporated by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting.

As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the disclosure, but instead as merely intended to highlight alternative or additional features that may or may not be utilized in a particular embodiment of the disclosure. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

As used in the claims below and throughout this disclosure, by the phrase “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the disclosure to the specific embodiments and examples described herein, but rather to also cover all modification and alternatives coming with the true scope and spirit of the disclosure.

### Systems for Chemical Analysis

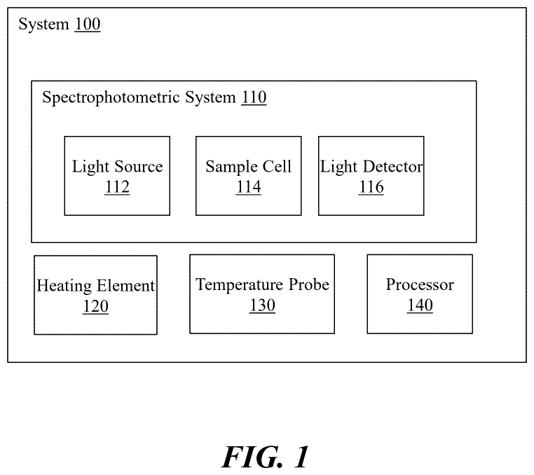

FIG. 1 is a block diagram that describes a system 100 for chemical analysis, according to some embodiments of the present disclosure. In some embodiments, the system 100 may include a spectrophotometric system 110, a heating element 120 for heating a sample cell 114 in the spectrophotometric system 110, a temperature probe 130, and a processor 140 configured to determine the concentration of the chemical by determining a slope of an absorbance-temperature curve of the sample and comparing the slope with a standard slope-concentration relationship of the chemical. The spectrophotometric system 110 may include a light source 112 and a sample cell 114 for the sample, and a light detector 116.

In some embodiments, the system 100 may be a self-contained and/or portable device. For example, the system 100 may include a simple spectrophotometric system 110 that is handheld. In some embodiments, the spectrophotometric system 110 may be miniaturized and have a predefined path length for the analyte. In some embodiments, one or more of the components may be reduced in size, including, for example, a reduction in size of the light source, sample cell, and light detector, which may allow these components to fit within a portable device. In some embodiments, the light source, sample cell and light detector may be fixed relative to each other within the portable device. In some embodiments, the system 100 may include an internal power source. In some embodiments, the system 100 may be handheld. In some embodiments, the system 100 may include a port for incorporating the analyte into the handheld device, for example, by dipping an end of the handheld device into a solution containing the analyte and thereby allowing the analyte to flow into the sample cell of the spectrophotometric system. In some embodiments, the system 100 may be a self-contained and portable, but otherwise include a flat bottom for placing the system on a flat surface. In some embodiments, the system may include simple but potentially variable light sources, such as an LED, and so the system may include, for example, two pathlengths to allow for a control measurement of any variability in the light source intensity.

In some embodiments, some of the components of system 100 may not necessarily be operably connected. For example, a heating element may be located apart from the spectrophotometric system 110. In some embodiments, the sample cell may be extracted and filled outside of the system 100. In some embodiments, the system 100 may include a pump for retrieving a solution containing an analyte from a source and then pumping the solution into the sample cell. In some embodiments, the system may be adapted for in-line continuous or on-demand monitoring of a chemical manufacturing line or purification system. In some embodiments, the system may be adapted for a benchtop system.

An aspect of the disclosure is directed to a spectrophotometric system 110 comprising a light source 112, a sample cell 114 for the sample, and a light detector 116. In some embodiments, the spectrophotometric system 110 may include a benchtop UV-Vis spectrometer adapted according to the disclosure. In some embodiments, additional components of system 100 may be incorporated within a standard benchtop UV-Vis spectrometer, such as a heating element, a temperature probe, a flow of nitrogen to reduce condensation and a pump for introducing an analyte, such as OPA, into a sample cell in the spectrophotometer.

In some embodiments, any number of detector elements may be used to measure the absorbance of a sample. A spectrometer may include a linear array, consisting of a plurality of detectors. For mid-IR measurements, pyroelectric and thermopile array systems or multiplexed lead sulfide and lead selenide arrays may be suitable. Other detector arrays, such as mercury cadmium telluride, or indium antimonide could also be used for IR measurements. An array may be optically interfaced with a grating, such as a holographic grating, which disperses the broadband radiation into its component wavelengths without the need for moving mechanical parts. In some embodiments, commercial array spectrometers may be employed, such as an S-2000 UV-vis spectrometer.

In some embodiments, a spectrophotometric system 110 may include of a light source 112, a sample cell 114 for the sample, and a light detector 116. In some embodiments, a handheld or portable system 100 may consist essentially of a processor, a heating element, a temperature probe, a light source 112, a sample cell 114 for the sample, and a light detector 116. In some embodiments, the handheld system may not include Large, heavy, or energy-intensive components. For example, a custom processor may be created for the handheld system. In some embodiments, bulky light sources and detectors could be replaced with miniaturized LEDs and compact photodiodes, respectively, to maintain functionality without the added bulk. In some embodiments, instead of incorporating a complex display or numerous buttons directly on the device, functionality might be offloaded to a connected smartphone app. Complex mechanical parts, like adjustable sample holders or manual knobs for changing settings, might also be excluded. These components can be prone to wear and increase the size of the device. In some embodiments, fixed sample cells or electronic controls through a digital interface could be utilized. In some embodiments, focusing on a narrower range of applications could allow for more specialized, efficient, and cost-effective devices. This specialization might involve designing the system to operate optimally within a specific temperature range, specific wavelength ranges, or for a particular set of chemicals (with or without glass sample holders, for example). Accordingly, a system consisting essentially of the above-described elements, may avoid bulk of processes associated with a broad range of calibration standards. Non-limiting examples of a light source 112, a sample cell 114 for the sample, and a light detector 116 are described herein.

### Light Source

In some embodiments, a light source may comprise a light source providing light at relevant wavelengths. In some embodiments, the relevant wavelengths may be in any of the UV, visible and infrared ranges. Ideally the light source provides a steady source of light, but in some embodiments, the spectrophotometric system 110 may provide for an optical control path to account for unstable light sources. A light source may include, but is not limited to, a classic UV-Vis lamp, an LED lamp, and a laser. In some embodiments, a sample may be exposed to one or more wavelengths of light emitted from one or more light sources (e.g., deuterium lamps, mercury arc lamps, tungsten lamps, light-emitting diodes, and/or laser diodes). In some embodiments, a sample may be exposed to an ultraviolet light source, e.g., a sanitizing solution, for testing. Examples of ultraviolet light sources include a gas discharge lamp, such as a mercury lamp, a deuterium lamp, a metal vapor lamp, or a single or plurality of light emission diodes emitting light in a wavelength range of about 200 nm to about 320 nm. The ultraviolet light source may be a mercury low pressure lamp with main line at about 254 nm or a UV lamp such as a Krypton gas discharge lamp. A light emission diode can be used as a light source as well. Light from the light source may be partially or fully absorbed by the sample depending on the chemical and concentration of the chemicals in the sample as well as the wavelength(s) of light used. Any unabsorbed light may pass through the sample cell and be transmitted to a signal detector (e.g., a variable-wavelength detector system or a diode array detector system).

In particular, deuterium lamps, mercury arc lamps, and tungsten lamps are relatively large compared to the physical size of a sample cell of a UV-VIS spectrophotometer. The light emitted from these light sources is spatially and spectrally broad and may benefit from optical conditioning. These light sources also benefit from pre-warming before use.

In some embodiments, light-emitting diodes (LEDs) can be used for a longer-lasting, smaller, and more cost-effective light source that does not require pre-warming before use. However, unlike the spectrally broad lamps mentioned above, LEDs may emit different wavelengths of light. Accordingly, the ability of any particular UV-VIS spectrophotometer setup may be tuned to detect a particular analyte, based on the spectral characteristics of the analyte and the configuration of the UV-VIS spectrophotometer (e.g., the emission wavelengths of the included LEDs). The detection needs of a user may change over time. As a result, the user may purchase additional equipment, such as a second UV-VIS spectrophotometer, to detect components with spectral characteristics outside of those detectable by a first UV-VIS spectrophotometer.

### Sample Cell

In some embodiments, the sample cell 114, may be a cuvette. Samples according to the disclosure could be liquid or gaseous. In some embodiments, the sample may be a powder in an attenuated total reflection ultraviolet (ATR) configuration. The cuvette is used to hold a sample in the spectrophotometer. The pathlength L through the sample is then the width of the cell through which the light passes through. Simple spectrophotometers may use cuvettes shaped like cylindrical test tubes, but more sophisticated ones use rectangular cuvettes, commonly, but not limited to, 1 cm in width. For visible spectroscopy, ordinary glass cuvettes may be used, but ultraviolet spectroscopy may employ special cuvettes made of a UV-transparent material such as quartz.

In some embodiments, a sample cell 114 may be any partially transparent container for the sample that will allow with suitable wavelength to pass through to the sample and to be absorbed. In some embodiments, the disclosure provides for quantitative attenuated total reflection ultraviolet (ATR-UV) spectroscopy that can be used to monitor concentration. UV-Vis ATR methods do not require light to pass directly through the sample and continue through the other side of a container. For example, the disclosure provides for methods that may be performed on a surface. In some embodiments, a sample cell 114 may be a flow cell. In some embodiments, the system 100 may include a reservoir that is operably connected to sample cell 114. The contents of such a sample cell 114 may be optionally recycled to the reservoir during or after the measurement.

### Light Detector

In some embodiments, any light detector 116 may be used to measure the light intensity after passing the sample cell 114. In some embodiments, a light detector may comprise a diffraction grating or a prism. In some embodiments, the light detector measures light at a specific wavelength or ranges of wavelengths. The light detector may include a wavelength filter to pass light in a relevant wavelength. In some embodiments, disclosed light detectors may comprise at least one of a spectrophotometer, photomultiplier tube (PMT), and a single channel light sensor. In some embodiments, the system 100 may also include at least one filter for measuring circular dichroism, and polarization.

The wavelengths that a light detector can detect depend on the design and specifications of the instrument. Generally, a spectrometer is capable of detecting a range of wavelengths within the electromagnetic spectrum, which includes radio waves, microwaves, infrared radiation, visible light, ultraviolet radiation, and X-rays. Preferred ranges of wavelengths may include infrared radiation, visible light, ultraviolet radiation ranges of the electromagnetic spectrum. The specific range of wavelengths that a spectrometer can detect will depend on the type of spectrometer, its design, and the type of detector used. For example, a spectrometer that is designed to measure visible light may have a wavelength range of 400 to 700 nanometers, while a spectrometer designed to measure ultraviolet radiation may have a range of 200 to 400 nanometers. In general, most modern spectrometers are capable of detecting a wide range of wavelengths across the electromagnetic spectrum, from the ultraviolet to the near infrared, although the exact range may vary depending on the specific instrument.

In some embodiments, the light detector used will depend on the chemical or sample of interest. For example, the specific wavelengths at which a sugar absorbs light can depend on the type of sugar and the specific chemical structure of its molecules. However, in general, sugars tend to absorb light in the ultraviolet and visible regions of the electromagnetic spectrum. For example, glucose, a common sugar, has been shown to absorb light at a wavelength of around 260 nanometers in the ultraviolet range. In the visible range, glucose has been found to absorb light at wavelengths around 480-490 nanometers. Other sugars, such as fructose, sucrose, and lactose, may have different absorption spectra and absorb light at similar but different wavelengths. The exact absorption properties of a sugar can also depend on the solution or matrix in which it is present, as well as the concentration of the sugar.

In some embodiments, the absorbance may be measured at a wavelength in the range of about 190 to about 800 nm. In some embodiments, the absorbance may be measured at a wavelength in the range of 300 to 400 nm. In some embodiments, the absorbance may be measured at a wavelength in the range of about 190 to about 1100 nm. In some embodiments, the absorbance may be measured at a wavelength greater than 800 nm. In some embodiments, the light detector may measure a range of wavelengths. In some embodiments, the light detector may measure at a narrow band of wavelengths. In some embodiments, the light detector may measure at a single wavelength.

In some embodiments, the absorbance may be measured through the proxy of fluorescence. As a prophetic example, a sample increases in absorbance with an increase in temperature, and more fluorophores absorb light. Accordingly, with a constant quantum yield, the increased absorbance will cause an increase in fluorescence. Additional corrections can be employed to account for the changing absorbance, constant/changing quantum yields, and temperature dependent fluorescence quenching (e.g. diffusion limited quenching). Accordingly, the light detector 116 may be a fluorescent detector, such as a PMT. In some embodiments, the fluorescent detector may be a time sensitive fluorescent detector and determine a fluorescent lifetime of the fluorophore which may also depend on temperature.

### Heating Element

An aspect of the disclosure is directed to a heating element to change the temperature of a sample. In some embodiments, a heating element may not be operably coupled to the instrument. In a non-limiting example, a sample may be measured at a first temperature in the spectrophotometer, then heated by a means exterior to the instrument. In some embodiments, the heating element may be incorporated into the instrument to heat the sample in situ. In some embodiments, the temperature may be measured within a range of about 20° C. to about 100° C.

In some embodiments, the heating element 120 may be any type of temperature controller. Heating elements according to the disclosure may be any device capable of changing the sample temperature including, but not limited to, an electric heater and a microwave. In some embodiments, the heating element 120 may be any of a thermoelectric device, a temperature-controlled water bath that circulates water at a controlled temperature, a resistance heater, and an infrared bulb to transfer heat. For example, the heating element may be a water-cooled temperature controller capable of heating and cooling a sample. In some embodiments, the heating element may be a thermoelectric device. The disclosed systems and methods also provide for the heating element to heat or cool the sample; however, at temperatures lower than the dew point, condensation may complicate determination of the sample's absorbance. Similarly, increased turbidity of the sample or the matrix may also complicate the determination of the sample's absorbance.

In some embodiments, the heater may be disconnected from the spectrophotometric system 110. In such embodiments, a sample cell 114 may be removed from the system, heated and replaced. In some embodiments, the heating element 120 comprises at least one of an electrical heating element, and a microwave. In some embodiments, the first temperature may be elevated compared to the second temperature. The second temperature may be closer to room temperature and may be achieved by passively cooling from the first temperature. While possibly less desirable due to potential issues with condensation, the heating element 120 may also be any device that changes the heat of the sample, including a cooling device. Any issues with condensation could cause artefacts in the absorbance spectra of the sample, but could be mitigated by, for example, a stream of dry gas passing around the sample window.

In some embodiments, a sample cell may be in contact with or adjacent to a temperature control element (e.g., a heating element and/or a cooling element, such as a Peltier heating and cooling device) that is configured to perform thermal cycling. The Peltier can aid in maintaining a constant temperature in each chamber or increase the temperature or decrease the temperature at a desired or otherwise predetermined heating or cooling rate, respectively. Alternative heating and cooling elements such as circulating air, water or other gases or liquids of different temperatures, IR heating, and other methods well known to one skilled in the art are also possible with air temperature control and IR heating providing advantages of non-contact. In certain embodiments, a temperature control element (e.g., a heating and cooling element, such as a Peltier heating and cooling device) is configured to move to come into contact with or become adjacent to the sample cell, which may in turn be within a reaction chamber or continuous manufacturing process.

In some embodiments, a cool sample and a warm sample may be measured simultaneously in two channels, which may be parallel and use the same light source or use a different optical path and a different detector. In such embodiments, the heating element may be constantly operated to continually heat a sample passing through one of the parallel channels in the instrument, while the other channel remains at a constant temperature.

### Temperature Probe

An aspect of the disclosure is directed to a temperature probe. In some embodiments, the temperature probe may not be operably coupled to the spectrophotometer. In a non-limiting example, a sample may be measured at a first temperature before being placed in the spectrophotometer. In some embodiments, a temperature probe may be a thermocouple, any type of digital or non-digital thermometer, for example, a resistance thermometer that may be attached onto the measuring surface with a physical contact)

In some embodiments, the temperature probe 130 may be a spectroscopic probe of temperature. For example, the temperature probe may be an infra-red (IR) probe that provides local or remote detection of temperature, and a Raman based temperature probe that provides an indication of the sample's temperature. Additionally, or in the alternative, the temperature probe may monitor a temperature dependent spectroscopic feature, such as peak shifting and relative absorption/emission at two wavelengths. While the absorbance features of a chemical compound may overall increase/decrease with temperature, the absorbance features may also shift the peak of the feature to a higher or lower wavelength. A temperature probe may also include monitoring the peak of a chemical's absorbance feature to monitor the overall temperature of the sample.

There are various technologies for measuring the temperature of a measurement target any of which may be employed according to the disclosure. Among them, the radiation temperature measurement technique is a technique for measuring the surface temperature of the measurement object in a non-contact manner by using the radiated light from the measurement object and has been put to practical use as a radiation thermometer.

### Ortho-Phthalaldehyde (OPA)

In some embodiments, the chemical may be a molecule with an absorbance that changes with temperature. In some embodiments, the chemical may be selected from a conjugated molecule with labile protons, and a solvated molecule. In some embodiments, the chemical may be selected from Ortho-phthalaldehyde (OPA), glucose, and a protein.

Without being bound to a single theory of operation, OPA is expected to form hydrates, especially the cyclic hydrates, in aqueous solutions due to ortho positioning of the two aldehyde groups. Therefore, the absorbance may decrease as the hydration decreases the aromatic conjugated system as the aldehyde double bonds disappear during hydration. Accordingly, the disclosure reports that OPA absorbance at about 340 nm changed measurably with sample temperature.

In some embodiments, systems and methods of the disclosure may provide an accuracy of plus/minus 0.1 w % for OPA concentrations near minimum efficacious concentration of approximately 0.3 w %. In some embodiments, the system 100 may provide an accuracy of plus/minus 0.01 w % for OPA concentrations near minimum efficacious concentration of approximately 0.3 w %. In some embodiments, the system 100 may provide an accuracy of plus/minus 0.05 w % for OPA concentrations near minimum efficacious concentration of approximately 0.3 w %.

In some embodiments, the accuracy may be quantified by the standard error of a regression. The disclosure provides for standard errors of less than 0.01, less than 0.005, and less than 0.002. In some embodiments, the system may reference a previously determined calibration curve, and may only require taking measurements of a sample at a first temperature and/or at a first temperature and at a second temperature. Accordingly, the accuracy may be quantified by the standard error of a regression of the reference curve and/or by the reproducibility of the measured absorbance/temperature values of the sample.

### Methods of Determining Concentration

Methods of the disclosure may include manual and machine processing methods to record absorbance and the corresponding sample temperature, and to process the data to obtain an absorbance temperature slope (k). An aspect of the disclosure is directed to a processor configured to determine the difference between a sample's absorbance for two temperatures, obtain an absorbance temperature relationship, and determine a sample's concentration. Similarly, an aspect of the disclosure is directed to a module for a processor configured to determine concentrations of samples using temperature/absorbance relationships.

The present disclosure provides improved methods for accurately measuring the concentration of OPA in a sample using a spectrophotometer. In some embodiments, a method may involve the following steps:

Preparation of OPA standard solutions: A series of OPA standard solutions may be prepared at known concentrations, ranging from, for example, 0.1% to 0.6% (w/v). In some embodiments, the concentrations may have an absorbance that ranges from 0.01 a.u. to 2 a.u. in a sample cell with a path length that may range from 0.1 cm to 4 cm. These standard solutions may be prepared by diluting a stock solution of OPA in a suitable solvent, such as water or aqueous buffer.

Measurement of absorbance at a first temperature: The absorbance of each standard solution may be measured at a specific wavelength, such as 365 nm, using a spectrophotometer. The spectrophotometer would generally be calibrated prior to use to ensure accurate measurements. A temperature probe may be used to take a temperature reading of the sample.

Heating or cooling the sample. The sample cell may be removed from the spectrophotometer or stay in the sample chamber for heating or cooling. A temperature controller may be used to maintain and constantly monitor the temperature of the sample. In some embodiments, disclosed methods may comprise heating the sample to a first temperature and letting the sample cool to a second temperature.

Measurement of absorbance at a second temperature: The absorbance of each standard solution may be measured at the same specific wavelength, e.g., 365 nm, using a spectrophotometer. The same temperature probe may be used to take a temperature reading of the sample.

Construction of a slope-concentration standard curve: A standard curve may be constructed by plotting the concentration of each standard solution against its corresponding change in absorbance per unit temperature value. The standard curve may be generated using any suitable software, such as Excel or GraphPad Prism.

Optionally, a standard concentration calibration curve may be constructed. A standard curve may be constructed by plotting the concentration of each standard solution against its corresponding absorbance value. The standard curve may be generated using any suitable software, such as Excel or GraphPad Prism.

Determination of OPA concentration in a sample: The concentration of OPA in a sample may be determined by measuring the absorbance of the sample at the specific wavelength, at a first temperature and a second temperature, using the spectrophotometer. The change in absorbance per unit temperature value is then converted to a concentration value using the temperature-concentration standard curve.

In some embodiments, the standard slope-concentration curve for the chemical may be provided by determining the absorbance-temperature relationship of a chemical standard at one or more known concentrations. In some embodiments, the disclosed methods provide an R-squared value of 0.99. In some embodiments, the disclosed methods provide an R-squared value of at least 0.99. In some embodiments, the disclosed methods provide an R-squared value of at least 0.999. In some embodiments, a processor may be provided with information on a previously run standard calibration curve. In some embodiments, the processor may be configured to measure a standard calibration curve. In some embodiments, the chemical may be Ortho-Phthalaldehyde (OPA).

According to some embodiments of the present disclosure a processor may determine a first absorbance of the sample at a first temperature. The processor may also provide information on the absorbance-temperature relationship of the chemical and determine the concentration of the chemical in the sample by correlating the first absorbance with the information on the absorbance-temperature relationship of the chemical. For example, if the processor is provided information on a baseline absorbance of a sample at one temperature and a standard calibration curve, the disclosed methods and systems may proceed with information on the sample's absorbance at just one experimentally determined temperature. In other embodiments, the information on the absorbance-temperature relationship of the chemical includes a second absorbance of the sample at a second temperature.

In some embodiments, the information on the absorbance-temperature relationship may include a plurality of data points. For example, a sample may be heated to an elevated temperature and the absorbance and temperature may be measured while the sample passively cools. In such embodiments, it may be desirable to take quick scans of the sample's absorbance such that the temperature of the sample has not changed significantly during the absorbance measurement. Quick scans may be achieved by lowering integration time from a light detector or limiting the wavelengths the absorbance is measured from (including limiting to a single wavelength). Alternatively, the sample may be measured at a stable temperature provided by a temperature controller, where the entirety of the sample has stabilized at a particular temperature.

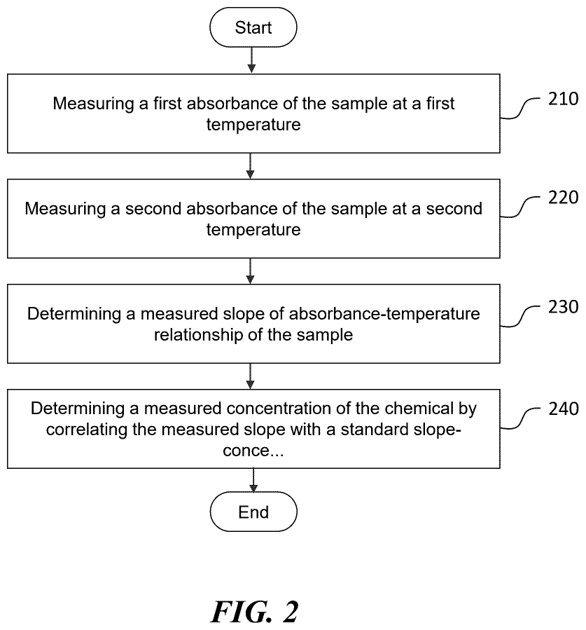

FIG. 2 is a flowchart that describes an analytical method for measuring a concentration of a chemical in a sample, according to some embodiments of the present disclosure. In some embodiments, at 210, the analytical method may include measuring a first absorbance of the sample at a first temperature. At 220, the analytical method may include measuring a second absorbance of the sample at a second temperature. At 230, the analytical method may include determining a measured slope of absorbance-temperature relationship of the sample. At 240, the analytical method may include determining a measured concentration of the chemical by correlating the measured slope with a standard slope-concentration curve for the chemical. The steps of the analytical method may include 210 to 240. In some embodiments, an accuracy of plus/minus 0.01 w % or better for OPA concentrations near minimum efficacious concentration of approximately 0.3 w % may be achieved.

FIG. 2 shows a flowchart that describes one of many analytical methods that may be used to measure an unknown concentration of a chemical within a sample. Other general methods are expressly contemplated that also use a slope-concentration relation quantitatively established with known concentrations. For example, while chemical/physical transformations may often yield convoluted and highly overlapping spectroscopic data, isometric points may be used to extract useful information from such datasets. Isometric points are points in a spectrum with a constant signal intensity throughout the progress of a chemical/physical transformation. An analysis with isometrically normalized signal intensities grants direct access to the degree of conversion of a transformation, if one has suitable reference spectra for the starting material and product. Thus, without any prior knowledge about the reactants, one can quantitatively follow their interconversion from messy spectroscopic data. Such principles can be extended to any situation where isometric points arise, such as for titration experiments with isometric points or electrochemical studies. Such examples may not require any previous calibration of equipment or knowledge of extinction coefficients or quantum yields.

In some embodiments, an analysis of isometrically normalized signal intensities may proceed by using the presence of a (pseudo-) isometric point as well as knowledge of the reference values Iφ/ψ,E and Iφ/ψ,P for the starting material and product of the transformation (both of which may be available from a single measurement each or fitted from known distributions). Iφ/ψ is the experimentally obtained isometrically normalized signal intensity (signal intensity at the arbitrary φ divided by the signal intensity at the isometric point ψ) and Iφ/ψ,E and Iφ/ψ,P are the isometrically normalized signal intensities of pure E and pure P. More methods and examples, including principal component analyses are also contemplated and may be employed to execute the disclosed methods. In some embodiments, the disclosed methods may be used in combination with, or incorporated within certain analytical techniques known to a person of ordinary skill in the art.

Chemicals Whose Absorbance Changes with Varying Temperature

Disclosed herein are certain compounds that are well suited to this procedure. Disclosed herein are certain aromatic compounds such as benzene, toluene, xylene, phenol, and aniline, each of which may be substituted or unsubstituted. Additionally, certain molecules are known to change conformation with temperature, including sugars and proteins.

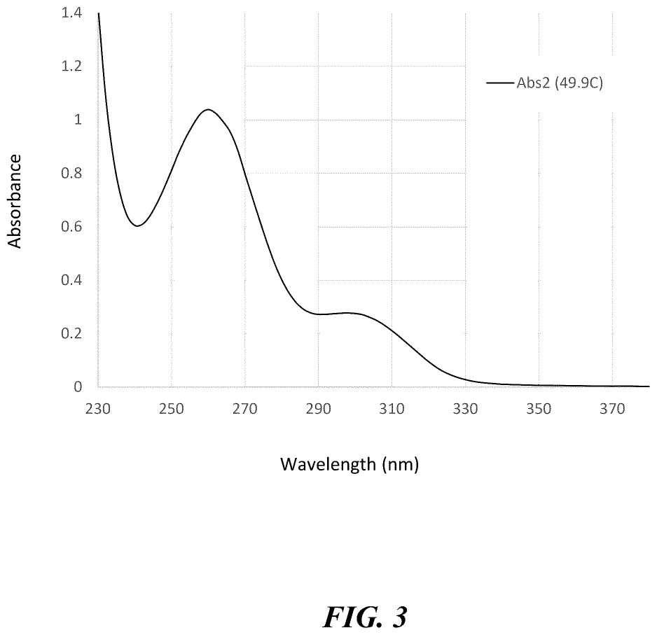

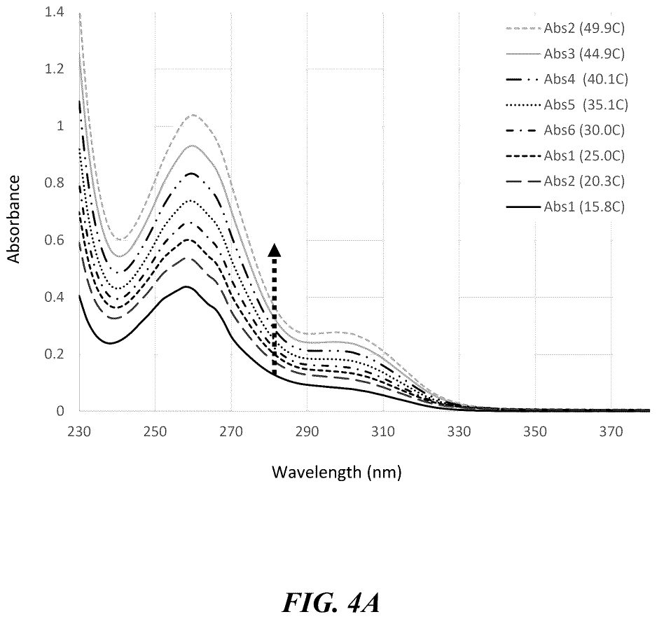

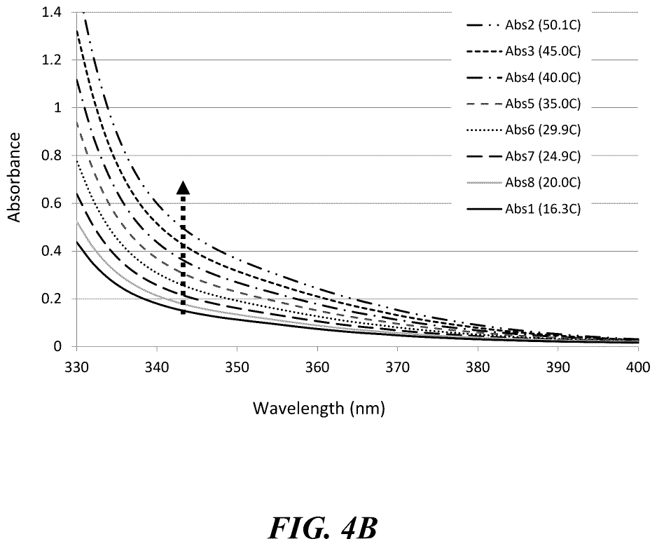

FIG. 3 illustrates an absorption spectrum of OPA. The OPA spectrum includes features throughout the UV and in the visible range, however, the largest absorption features are within 230 nm to 330 nm. FIG. 4A illustrates the absorption spectra of OPA over 230 nm to 380 nm and includes many absorbance features that change with temperature. Any of these absorbance features that change with temperature may be used according to the disclosure. FIG. 4B illustrates the absorption spectra of OPA over 330 nm to 400 nm, and does not include a single distinct absorbance peak that changes with temperature; however, any of these wavelengths may be used according to the disclosure. The same sample was used for FIG. 4B and for FIG. 4A (diluted relative to 4B), but because the absorbance varied significantly with wavelength, different concentrations were used for different wavelength ranges to limit absorbance within measurable range (normally below 2).

Some of the references disclose that certain chemicals can have temperature dependent changes in absorbance. Some references may employ linear or quasi linear corrections to measured absorbances (as opposed to absolute concentration determination via temperature) to determine concentrations of chemicals of interest. Such corrections may be used to correct for temperature changes, but none of the references contemplate determination of concentration by intentionally changing temperatures. Similarly, the references do not contemplate determining the concentration of the chemical by determining a slope of an absorbance-temperature curve of the sample and comparing the slope with a standard slope-concentration relationship of the chemical.

### Continuous Monitoring

An aspect of the disclosure is directed to systems and methods in a continuous chemical monitoring environment; however, it should be understood that the scope of the disclosure is not limited to that particular environment, and that one skilled in the art will appreciate that the systems and methods described herein can be embodied in various forms. Accordingly, any structural and/or functional details disclosed herein are not to be interpreted as limiting the systems and methods, but rather are provided as attributes of a representative embodiment and/or arrangement for teaching one skilled in the art one or more ways to implement the systems and methods, which may be advantageous in other contexts.

In some embodiments, the disclosed systems may be applied to a continuous chemical process or disinfection process. For example, in a disinfection system, a reservoir of OPA may be used to disinfect medical equipment and should maintain a minimum concentration of OPA. Accordingly, the disclosed methods and systems may measure the absorbance of OPA within a sample that is withdrawn from the reservoir. In some embodiments, the absorbance of OPA within a sample may be measured through an optical port in the reservoir. Similarly, in a continuous chemical process, such as drug capsule manufacturing, a sample may be either extracted or measured in situ from a manufacturing line to determine concentrations or relative concentrations of any relevant ingredients. Depending on the application, samples may be discarded after measurement or re-introduced into a reservoir. The disclosure provides for non-destructive measurement of chemicals of interest.

An aspect of the disclosure is directed to process analytical technique (PAT) enabled continuous manufacturing process where in some step within the continuous manufacturing process, a PAT compatible system according to the disclosure measures material attributes of ingredients used during a continuing manufacturing process. In some embodiments, PAT enabled continuous manufacturing may include a system according to the disclosure and any of a twin screw granulator, a temperature controller extruder, and a fluidized bed dryer.

Continuous manufacturing may deliver high quality and highly consistent product with on-line monitoring and control and systems and methods according to the disclosure may be used to determine in situ concentrations of in stream samples or samples removed from a continuous manufacturing process. Continuous manufacturing also facilitates quality by design development with a “data rich” design space and an easier to understand impact of upstream variables on the downstream process and final product quality, but requires information on the relative concentrations of mixtures-which may be difficult to determine. Accordingly, pharmaceutical compositions may be measured and tuned early on commercial scale equipment that avoids scale-up risks and formulation changes later in development. Finally, methods and systems employed according to the disclosure may provide improved process control, reduced product handling, and real time efficiencies. The overall result of the disclosed systems and methods is a more robust, controllable, and scalable process that has fewer process checks resulting in increased product quality and therefore greater patient safety.

### EXAMPLES

The disclosure provides the accompanying experiments and examples, without limiting the scope of the disclosure. The following examples were performed with a spectrophotometer M&A Instruments Inc. Model 5200PC. However, as provided for in the disclosure, the disclosed methods and systems may be performed with any type of light detector, including for example a PMT, with or without any optical filters. The following samples had their temperature measured using a Fluke, Model 54 IIB thermometer with a thermal couple probe. In some embodiments, any temperature probe may be used, including an IR probe. In some embodiments, a sample may be placed in a water bath of a known temperature.

The examples used the following reagents: Cidex OPA solution, Metrex OPA Plus solution, OPA, Potassium phosphate dibasic, Potassium phosphate monobasic, and Deionized water. OPA solutions were tested with various factors including composition, pH, and concentration, which were varied because of manufacturers' formulation, conditions and length of storage, and controlled dilutions.

The following procedure was used to measure the absorbance temperature relationship and measure a slope. First, a zero absorbance of the spectrophotometer was calibrated with deionized water as reference. Other baseline references may be used, including any matrix adjusted baseline. Then approximately 18 mL of OPA solution in a 20 mL scintillation vial was heated in a microwave to over 50° C. Approximately 3 mL of that warmed solution was transferred into a 1 cm cuvette (polystyrene or PMMA) equipped with a thermal couple connected with a Fluke thermometer. The sample temperature passively cooled and was recorded by the thermometer.

The absorbance reading interval (Kinetic Scan Mode) was set the same as the temperature recording interval such that every absorbance measurement would correspond to the temperature of the sample when the absorbance measurement was made. Recordings of the absorbance at a specific wavelength and temperature of the solution were started simultaneously. The temperature values were matched with their corresponding absorbance values. Thus, the Absorbance (A)-Temperature (T) curve were plotted, fit to a linear model, and the A-T change slope was obtained. These steps were repeated as needed, such as for repeatability studies.

### Data Processing and Results

The following examples demonstrate one possible method for data recording and processing. In particular the following methods include a plurality of data points of absorbance and temperature; however, the disclosed methods provide for measuring a single data point and references a standard, measuring two data points and creating a reference, and measuring a plurality of data points. The following examples demonstrate high R-Squared values. R² or the coefficient of determination is a statistical measure in a regression model that determines the proportion of variance in the dependent variable that can be explained by the independent variable. Accuracy may also be represented as the standard error of the predicted y-value for each x in a regression. The following examples demonstrate results obtained with procedures that were not optimized. For example, the sample solutions for absorbance reading were not filtered and dust-like particles were observed in some samples, especially after repeated testing. Accordingly, some values of the absorbance temperature plot may include some systematic error, but the following experiments still demonstrate the reproducibility of the disclosed methods.

Tools for comparing models also include F-Tests, Bayes' Factors, Information Criteria, and out-of-sample predictive accuracy. In some embodiments, the accuracy may be determined by the precision of the measurement that is defined by the last significant figure in an error analysis. In some embodiments, the uncertainty of the measurement may be defined as the standard error of the regression. The following examples provided standard errors of less than 0.01, less than 0.005, and less than 0.002.

### Example 1

In Example 1 (comprising runs 1-6), the absorbance was recorded with Kinetic Mode of a spectrophotometer. The digital absorbance readings were set with intervals that matched temperature recording. The sample temperature was recorded with a Fluke 54 II B Model thermometer and converted into an Excel file. The temperature readings were set with intervals that matched absorbance recording. The absorbance and temperature values were collated and processed in an Excel sheet. Table 1 demonstrates 6 replicates of full strength OPA for repeatability test on Day 3. The temperature range between 42° C. to 37° C. (107.6-98.6° F.) was chosen as examples for analysis. Temperature values closest to targets 107.6 and 98.6° F. were chosen and could be varied in any appropriate range. The absorbance-temperature (A-T) curve was linear, and a slope was obtained for every trial of the sample.

TABLE 1
Examples of slope obtained from Abs-Temperature curve of Full Strength OPA on Day 3.

| Rep 1 | | Rep 2 | | Rep 3 | | Rep 4 | | Rep 5 | | Rep 6 | |
|---|---|---|---|---|---|---|---|---|---|---|---|
| Temp | | Temp | | Temp | | Temp | | Temp | | Temp | |
| (F.) | Abs. | (F.) | Abs. | (F.) | Abs. | (F.) | Abs. | (F.) | Abs. | (F.) | Abs. |
| 110.4 | 0.7194 | 109.3 | 0.7064 | 109.2 | 0.7131 | 109.1 | 0.7157 | 110.1 | 0.7277 | 110.3 | 0.7305 |
| 110.2 | 0.7171 | 108.9 | 0.7024 | 108.9 | 0.7081 | 108.9 | 0.7107 | 109.6 | 0.7212 | 109.9 | 0.7248 |
| 109.9 | 0.7133 | 108.7 | 0.6986 | 108.5 | 0.7024 | 108.5 | 0.7057 | 109.1 | 0.7145 | 109.5 | 0.7193 |
| 109.6 | 0.7091 | 108.3 | 0.6949 | 108.1 | 0.698 | 108.2 | 0.705 | 108.7 | 0.7077 | 109.1 | 0.7133 |
| 109.3 | 0.7049 | 107.9 | 0.6912 | 107.7 | 0.693 | 107.9 | 0.6986 | 108.1 | 0.7012 | 108.6 | 0.7078 |
| 109 | 0.7004 | 107.5 | 0.6848 | 107.3 | 0.6885 | 107.5 | 0.6925 | 107.7 | 0.6952 | 108.2 | 0.7025 |
| 108.6 | 0.6965 | 107.1 | 0.68 | 106.9 | 0.6836 | 107.1 | 0.6878 | 107.2 | 0.6891 | 107.7 | 0.6964 |
| 108.3 | 0.6917 | 106.7 | 0.6761 | 106.5 | 0.6791 | 106.7 | 0.6836 | 106.7 | 0.6832 | 107.3 | 0.6914 |
| 107.9 | 0.6866 | 106.3 | 0.6711 | 106.1 | 0.6741 | 106.3 | 0.6787 | 106.3 | 0.6778 | 106.9 | 0.6869 |
| 107.5 | 0.6818 | 105.9 | 0.6654 | 105.7 | 0.6691 | 105.9 | 0.6736 | 105.8 | 0.6719 | 106.5 | 0.6824 |
| 107.1 | 0.6766 | 105.5 | 0.6601 | 105.3 | 0.6638 | 105.5 | 0.6691 | 105.4 | 0.6665 | 106 | 0.6759 |
| 106.7 | 0.672 | 105.1 | 0.6547 | 104.9 | 0.6589 | 105.1 | 0.6651 | 104.9 | 0.6608 | 105.5 | 0.6697 |
| 106.3 | 0.6671 | 104.7 | 0.6495 | 104.5 | 0.6539 | 104.8 | 0.6602 | 104.5 | 0.6552 | 105.1 | 0.6644 |
| 105.8 | 0.6618 | 104.3 | 0.6446 | 104.1 | 0.6485 | 104.4 | 0.655 | 104 | 0.6499 | 104.7 | 0.6593 |
| 105.4 | 0.6567 | 103.9 | 0.6399 | 103.7 | 0.6436 | 104 | 0.6496 | 103.6 | 0.6445 | 104.3 | 0.6542 |
| 105 | 0.6515 | 103.5 | 0.6349 | 103.3 | 0.6388 | 103.6 | 0.6451 | 103.1 | 0.6393 | 103.8 | 0.6489 |
| 104.5 | 0.6463 | 103.1 | 0.6308 | 102.9 | 0.6341 | 103.2 | 0.6399 | 102.7 | 0.634 | 103.4 | 0.6436 |
| 104.1 | 0.641 | 102.7 | 0.6253 | 102.5 | 0.6292 | 102.8 | 0.6352 | 102.3 | 0.629 | 103 | 0.6384 |
| 103.7 | 0.6359 | 102.3 | 0.6205 | 102.1 | 0.6242 | 102.4 | 0.6302 | 101.9 | 0.624 | 102.5 | 0.6333 |
| 103.3 | 0.6308 | 101.9 | 0.6155 | 101.7 | 0.6194 | 102 | 0.6259 | 101.5 | 0.6191 | 102.1 | 0.628 |
| 102.9 | 0.6256 | 101.5 | 0.6109 | 101.3 | 0.6148 | 101.6 | 0.6211 | 101.1 | 0.6144 | 101.7 | 0.6232 |
| 102.5 | 0.6206 | 101.1 | 0.6066 | 100.9 | 0.6104 | 101.2 | 0.6168 | 100.7 | 0.6095 | 101.3 | 0.6183 |
| 102.1 | 0.6157 | 100.7 | 0.6018 | 100.5 | 0.6061 | 100.8 | 0.6123 | 100.3 | 0.605 | 100.9 | 0.6134 |
| 101.6 | 0.6111 | 100.3 | 0.5973 | 100.1 | 0.6017 | 100.5 | 0.6077 | 99.9 | 0.6004 | 100.5 | 0.609 |
| 101.2 | 0.6062 | 99.9 | 0.5928 | 99.7 | 0.5972 | 100.1 | 0.6034 | 99.5 | 0.5959 | 100.1 | 0.6046 |
| 100.8 | 0.6013 | 99.5 | 0.5887 | 99.4 | 0.593 | 99.7 | 0.599 | 99.1 | 0.5914 | 99.7 | 0.6004 |
| 100.4 | 0.5965 | 99.1 | 0.5842 | 99 | 0.5888 | 99.3 | 0.595 | 98.7 | 0.5868 | 99.4 | 0.596 |
| 100 | 0.5918 | 98.7 | 0.58 | 98.6 | 0.5847 | 99 | 0.591 | 98.3 | 0.5826 | 99 | 0.592 |
| 99.6 | 0.5873 | 98.4 | 0.5757 | 98.3 | 0.5805 | 98.6 | 0.5872 | 98 | 0.5783 | 98.6 | 0.5875 |
| 99.3 | 0.5832 | 98.1 | 0.5715 | 97.9 | 0.5764 | 98.3 | 0.5831 | 97.6 | 0.5745 | 98.3 | 0.5837 |
| 98.9 | 0.5786 | 97.7 | 0.5677 | 97.5 | 0.5726 | 97.9 | 0.5794 | 97.3 | 0.571 | 97.9 | 0.5797 |
| 98.5 | 0.5745 | 97.3 | 0.5643 | 97.2 | 0.5686 | 97.6 | 0.5755 | 96.9 | 0.5671 | 97.5 | 0.5756 |
| 98.1 | 0.5701 | 97 | 0.5604 | 96.9 | 0.5648 | 97.2 | 0.5715 | 96.5 | 0.5632 | 97.2 | 0.5733 |
| 97.7 | 0.5661 | 96.6 | 0.5563 | 96.5 | 0.5612 | 96.9 | 0.5679 | 96.2 | 0.5593 | 96.8 | 0.57 |
| 97.4 | 0.5622 | 96.3 | 0.5525 | 96.1 | 0.5576 | 96.5 | 0.5651 | 95.9 | 0.5554 | 96.5 | 0.5642 |
| 97 | 0.558 | 95.9 | 0.5491 | 95.8 | 0.554 | 96.2 | 0.5615 | 95.5 | 0.5516 | 96.1 | 0.5607 |
| 96.7 | 0.5543 | 95.6 | 0.5457 | 95.5 | 0.5513 | 95.9 | 0.5572 | 95.1 | 0.5481 | 95.8 | 0.5571 |
| 96.3 | 0.5502 | 95.3 | 0.542 | 95.1 | 0.548 | 95.6 | 0.5533 | 94.8 | 0.5446 | 95.5 | 0.5533 |
| 95.9 | 0.5463 | 94.9 | 0.5385 | 94.9 | 0.5445 | 95.3 | 0.5502 | | | 95.1 | 0.5499 |
| 95.6 | 0.5426 | | | | | 94.9 | 0.547 | | | 94.9 | 0.5462 |

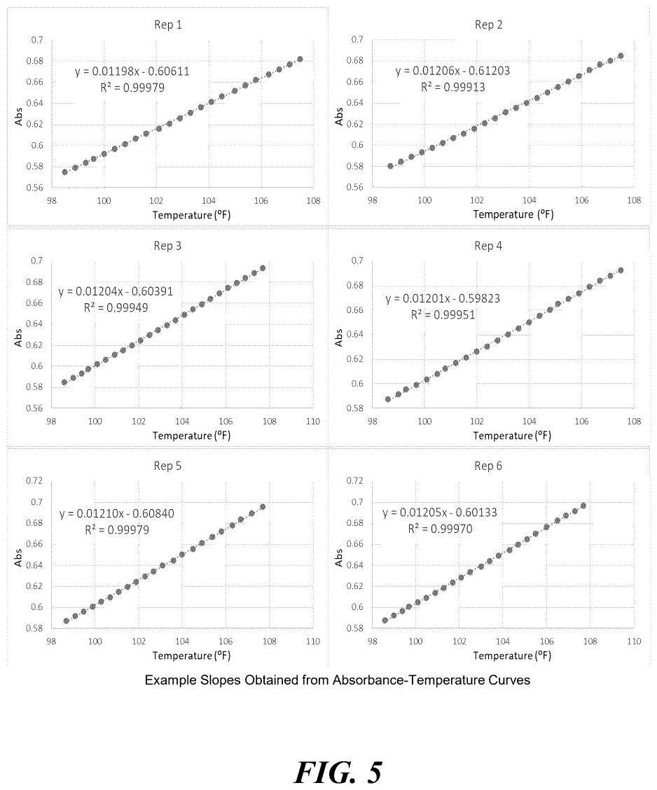

FIG. 5 shows six example best fit lines using linear regression on the six trial runs in Table 1 above. Each of the samples demonstrated a greater than 0.999 R-squared value and a standard error of less than 0.0018.

### Example 2

In example 2, experiments were performed that demonstrated the advantageous repeatability and reproducibility of the disclosed methods. In the following experiment a full strength (without dilution) Cidex OPA solution was tested in six replicates each day for three days, totaling 18 replicates. The overall relative standard deviation (RSD) for the 18 replicates was 0.87%. The results are summarized in Table 2.

TABLE 2
Repeatability/reproducibility of full
strength OPA solution slope (k × 10⁵)

| | Replicate # | | | | | | | |
|---|---|---|---|---|---|---|---|---|
| | 1 | 2 | 3 | 4 | 5 | 6 | Average | % RSD |
| Day 1 | 1185 | 1202 | 1198 | 1198 | 1189 | 1178 | 1200 | 0.87 |
| Day 2 | 1188 | 1200 | 1197 | 1205 | 1221 | 1215 | | |
| Day 3 | 1198 | 1206 | 1204 | 1201 | 1210 | 1205 | | |

Table 2 lists the values for the absorbance temperature curves (scaled by 10⁵) of six replicates over three days. These curves demonstrate the reliability of the method at the highest concentration; however, the disclosed methods have similar reliability at lower concentrations. The full-strength solution demonstrates promising potential for the disclosed methods, and the accuracy of measurement of OPA concentrations was investigated near minimum efficacious concentration (MEC) (0.3% claimed for Cidex OPA and Metricide OPA Plus Solution). An OPA solution at around 0.33% diluted from Cidex OPA was tested for four days, totaling 36 replicates. The relative standard deviation (% RSD) was observed to range from 0.76% to 1.85% within a day. The overall relative standard deviation (RSD) for the 36 replicates was 1.56%. The results are summarized in Table 3.

TABLE 3
~0.33% OPA solution slope (k × 10⁵) repeatability/reproducibility

| Replicate # | Day 1 | Day 2 | Day 3 | Day 4 |
|---|---|---|---|---|
| Rep 1 | 732 | 743 | 744 | 724 |
| Rep 2 | 735 | 741 | 739 | 738 |
| Rep 3 | 744 | 738 | 748 | 745 |
| Rep 4 | 736 | 744 | 748 | 735 |
| Rep 5 | 743 | 761 | 740 | 738 |
| Rep 6 | 732 | | 742 | |
| Rep 7 | 747 | | 732 | |
| Rep 8 | 753 | | | |
| Rep 9 | 743 | | | |
| Rep 10 | 747 | | | |
| Rep 11 | 735 | | | |
| Rep 12 | 751 | | | |
| Rep 13 | 734 | | | |
| Rep 14 | 730 | | | |
| Rep 15 | 734 | | | |
| Rep 16 | 720 | | | |
| Rep 17 | 744 | | | |
| Rep 18 | 698 | | | |
| Rep 19 | 712 | | | |
| Day average | 735.26 | 745.4 | 741.857 | 736 |
| Day % RSD | 1.85 | 1.21 | 0.76 | 1.04 |

| | |
|---|---|
| Overall average | 738.056 |
| Overall RSD (n = 36) | 1.56 |

### Example 3

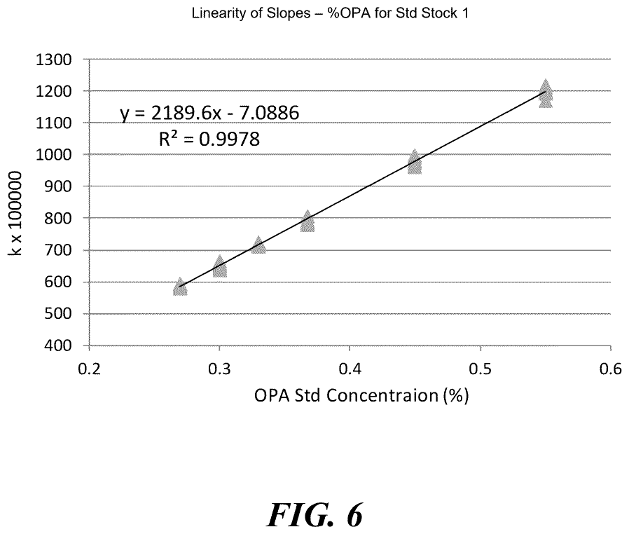

The linearity of Standard OPA solutions was investigated in Example 3. OPA Standard stock solutions at about 0.55% concentration were prepared from OPA, potassium phosphate monobasic and potassium phosphate dibasic. As the purity OPA material may be lower than reported on Certificate of Analysis due to degradation during storage, the real concentration OPA in the stock solutions may be lower. Five levels of OPA Standard Solutions were prepared by diluting a Standard Stock solution with deionized water. The five diluted Standard Solutions plus Standard Stock Solution yielded a total of six OPA concentrations. OPA Standard Stock solutions were prepared twice to test preparation repeatability. Each of these samples were then measured for the absorbance temperature relationship. The Standard Solutions were tested with multiple replicates for Absorbance-Temperature relationship and the slopes were obtained from curves for each concentration of OPA. The standard solutions from Standard Stock 1 were tested in 11 replicates over 8 days. The results are summarized in Table 4a and 4b, and shown in FIG. 6. The linearity coefficient was 0.9978 for 6 standard points, and 0.9999 if the curve is set at the intercept (crossing 0 point).

TABLE 4a
Slope values (k × 10⁵) of OPA Standard
Solutions 1-3 from Standard Stock 1

| | Std 1 | | Std 2 | | Std 3 | |
|---|---|---|---|---|---|---|
| Test | Std | k × | Std | k × | Std | k × |
| Day | OPA % | 100000 | OPA % | 10⁵ | OPA % | 10⁵ |
| Day 1 | 0.269694 | 587 | 0.30033 | 657 | 0.32992 | 721 |
| | 0.269694 | 584 | 0.30033 | 656 | 0.32992 | 721 |
| | 0.269694 | 586 | 0.30033 | 654 | 0.32992 | 724 |
| Day 2 | 0.269694 | 591 | 0.30033 | 664 | 0.32992 | 725 |
| Day 3 | 0.269694 | 593 | 0.30033 | 636 | 0.32992 | 715 |
| Day 4 | 0.269694 | 580 | 0.30033 | 646 | 0.32992 | 725 |
| Day 5 | 0.269694 | 582 | 0.30033 | 642 | 0.32992 | 714 |
| Day 6 | 0.269694 | 594 | 0.30033 | 653 | 0.32992 | 712 |
| Day 7 | 0.269694 | 593 | 0.30033 | 643 | 0.32992 | 709 |
| Day 8 | 0.269723 | 579 | 0.300271 | 650 | 0.329872 | 709 |
| | 0.269723 | 588 | 0.300271 | 648 | 0.329872 | 719 |

TABLE 4b
Slope values (k × 10⁵) of OPA Standard
Solutions 4-6 from Standard Stock 1

| | Std 4 | | Std 5 | | Std 6 | |
|---|---|---|---|---|---|---|
| Test | Std | k × | Std | k × | Std | k × |
| Day | OPA % | 10⁵ | OPA % | 10⁵ | OPA % | 10⁵ |
| Day 1 | 0.367514 | 784 | 0.44922 | 975 | 0.54986 | 1193 |
| | 0.367514 | 788 | 0.44922 | 980 | 0.54986 | 1196 |
| | 0.367514 | 794 | 0.44922 | 979 | 0.54986 | 1201 |
| Day 2 | 0.367514 | 805 | 0.44922 | 998 | 0.54986 | 1209 |
| Day 3 | 0.367514 | 790 | 0.44922 | 995 | 0.54986 | 1210 |
| Day 4 | 0.367514 | 778 | 0.44922 | 991 | 0.54986 | 1198 |
| Day 5 | 0.367514 | 807 | 0.44922 | 960 | 0.54986 | 1202 |
| Day 6 | 0.367514 | 788 | 0.44922 | 977 | 0.54986 | 1197 |
| Day 7 | 0.367514 | 787 | 0.44922 | 964 | 0.54986 | 1169 |
| Day 8 | 0.367519 | 781 | 0.449254 | 961 | 0.54986 | 1193 |
| | 0.367519 | 783 | 0.449254 | 972 | 0.54986 | 1217 |

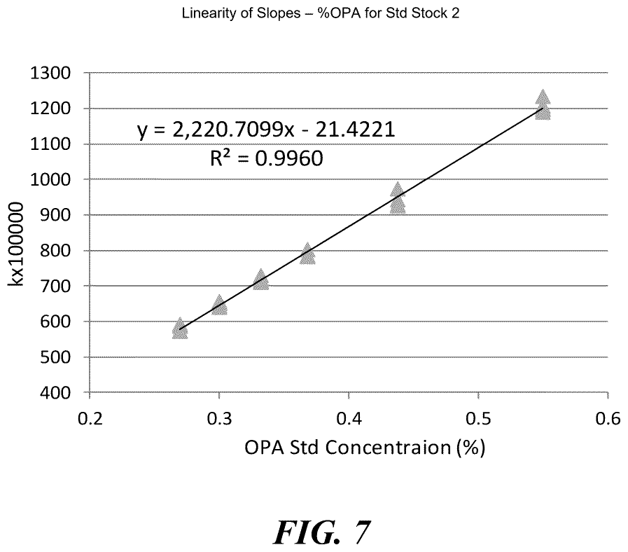

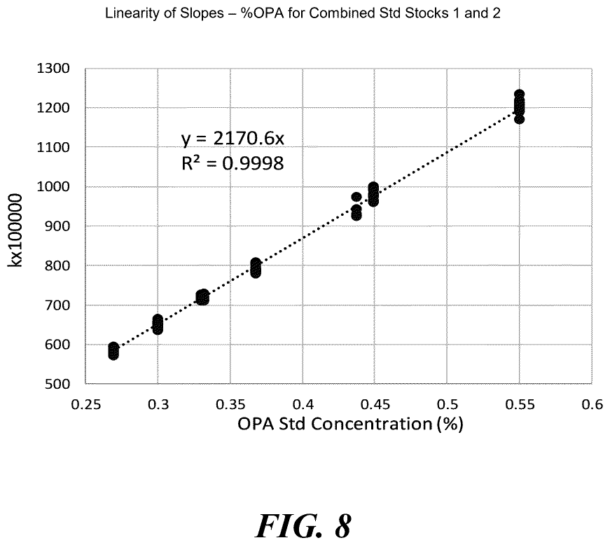

The standard solutions from Standard Stock 2 were tested in single replicate per day for 4 days. The results are summarized in Table 5 and shown in FIG. 7. The linearity coefficient was 0.9960 for 6 standard points, and 0.9997 if the curve is set at intercept (crossing 0 point). The linearity coefficient obtained from the combined two standard stock solutions was 0.9973 for 6 standard points, and 0.9998 if the curve is set at intercept (shown in FIG. 8).

TABLE 5a
Slope values (k × 10⁵) of OPA Standard
Solutions 1-3 from Standard Stock 2

| | Std 1 | | Std 2 | | Std 3 | |
|---|---|---|---|---|---|---|
| Test | Std | k × | Std | k × | Std | k × |
| Day | OPA % | 10⁵ | OPA % | 10⁵ | OPA % | 10⁵ |
| Day 1 | 0.2697 | 572 | 0.30014 | 639 | 0.33163 | 713 |
| Day 2 | 0.2697 | 593 | 0.30014 | 641 | 0.33163 | 709 |
| Day 3 | 0.2697 | 586 | 0.30014 | 652 | 0.33163 | 728 |
| Day 4 | 0.2697 | 573 | 0.30014 | 657 | 0.33163 | 719 |

TABLE 5b
Slope values (k × 10⁵) of OPA Standard
Solutions 4-6 from Standard Stock 2

| | Std 4 | | Std 5 | | Std 6 | |
|---|---|---|---|---|---|---|
| Test | Std | k × | Std | k × | Std | k × |
| Day | OPA % | 10⁵ | OPA % | 10⁵ | OPA % | 10⁵ |
| Day 1 | 0.36756 | 786 | 0.43718 | 941 | 0.54984 | 1196 |
| Day 2 | 0.36756 | 783 | 0.43718 | 924 | 0.54984 | 1206 |
| Day 3 | 0.36756 | 803 | 0.43718 | 972 | 0.54984 | 1233 |
| Day 4 | 0.36756 | 783 | 0.43718 | 929 | 0.54984 | 1188 |

### Example 4

The following Example 4 demonstrates the advantageous selectivity of the disclosed methods. The results are summarized in Table 6 and shown in FIG. 8. A major degradation product of OPA is 2-carboxybenzaldehyde (CBA), which also has overlapping absorbance with OPA. The impact of CBA on OPA test was preliminarily evaluated by first measuring Abs-temperature slope of a pure CBA sample, but then also by spiking CBA into an OPA solution of a typical concentration. In this example, the spiked CBA was 0.04387%, equivalent to about 10% of OPA degraded. The absorbance-temperature slope was obtained and compared (Table 6). Since the prepared % OPA of (CBA+OPA) solution was 0.275% higher than OPA solution, the CBA contribution for (CBA+OPA) solution was corrected as 4.07% (104.350−100.275). The CBA contribution to slope was less than 5% which demonstrates that OPA may be selectively measured. This minor contribution by CBA may be corrected by a factor of percentage coefficient or subtraction or by measuring at different wavelengths.

The OPA and (OPA+CBA) solutions were measured at several temperatures and their slopes were compared. At 103.1° F., the middle point of the temperature range 98.6-107.6° F., the total absorbances of (OPA+CBA) and OPA solutions were 0.4343 and 0.3593 a.u., respectively, for the first replicate. Accordingly, the absorbance ratio was 120.9/100, demonstrating that the CBA contribution to total absorbance (20.9%) is significantly higher than contribution to the total slope (4.35%), because even though it is a strong absorber that absorbance does not significantly change with temperature as compared to OPA.

TABLE 6
Slope values (k × 10⁵) of OPA solution and (OPA + CBA) solution

| Sample | OPA Slope | (OPA + CBA) Slope |
|---|---|---|
| Replicate 1 Slope | 698 | 726 |
| Replicate 2 Slope | 693 | 729 |
| Replicate 3 Slope | 701 | 728 |
| Average Slope | 697.33 | 727.67 |
| RSD, % | 0.58 | 0.21 |
| Prepared OPA, % | 0.353632 | 0.354606 |
| % OPA Ratio | 100 | 100.275 |
| Average Slope Ratio | 100 | 104.350 |

### Example 5

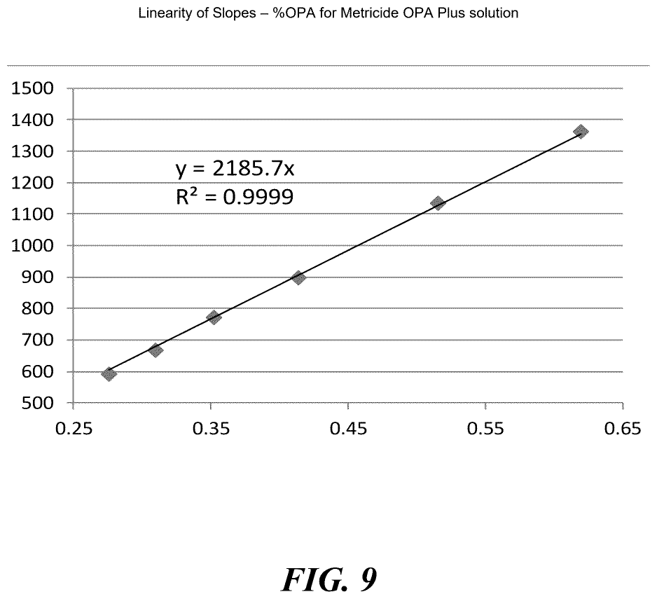

The following Example 5 tests the efficacy of the disclosed methods on different commercial OPA formulations. The results are summarized in Table 7 and shown in FIG. 9. In addition to pure OPA, and the other OPA commercial solution, the disclosed methods were applied to Metricide OPA Plus Solution. The real concentration of the Metricide OPA Plus solution is unpublished, the full-strength concentration was approximated as 0.6%, and the following experiment was conducted according to the procedure to determine slope, with the results summarized in Table 7. The example verified the linearity of the absorbance relationship in the relevant temperature range. The linearity coefficient was 0.9999 (intercept set) or 0.9998 (non-intercept set) which validates this method as applied to Metricide OPA Plus Solution. The measured % OPA values were obtained from the overall calibration equation y=2170.6x (see FIG. 9).

TABLE 7
OPA solution diluted from Metricide OPA Plus Solution

| Sample # | Calculated % OPA¹ | k × 10⁵ | Measured % OPA |
|---|---|---|---|
| 6 | 0.6 | 1362 | 0.6275 |
| 5 | 0.499554 | 1134 | 0.5224 |
| 4 | 0.400418 | 898 | 0.4137 |
| 3 | 0.341122 | 771 | 0.3552 |
| 2 | 0.300097 | 667 | 0.3073 |
| 1 | 0.267459 | 591 | 0.2723 |

Note:
¹Assuming full strength OPA = 0.6%

### Example 6

The following test results demonstrate the applicability of systems and methods according to the disclosure for a wide range of OPA concentrations of orthophthalaldehyde (OPA), such as at concentrations of 0.002-0.008% and 0.03-0.1%. Example 6 used the following equipment, materials, and methods used to measure the absorbance (A)-Temperature (T) slope of diluted ortho-phthalaldehyde (OPA) solutions. The primary instruments employed in this study were a spectrophotometer, specifically Model 5200PC from Metash Instruments Inc., and a thermometer, the Fluke Model 54 IIB. The reagents used included Cidex OPA solution and deionized water. The experimental procedure involved preparing five levels of diluted OPA solutions by mixing Cidex OPA solution with deionized water, aiming to study the effect of dilution on the A-T slope.

The spectrophotometer's zero absorbance was calibrated using deionized water as a reference. Approximately 18 mL of OPA solution was then heated in a 20 mL scintillation vial using a microwave until it reached over 50° C. Subsequently, about 3 mL of this warmed solution was transferred into a 1 cm quartz cuvette, which was equipped with a thermal couple linked to a Fluke thermometer for temperature recording. The experiment recorded the sample temperatures and matched them with corresponding absorbance values to create an Absorbance (A)-Temperature (T) curve. By analyzing this curve, the slope of the A-T changes was obtained. This procedure, from heating the solution to plotting the A-T curve, was repeated in triplicate to ensure repeatability and reliability of the data.

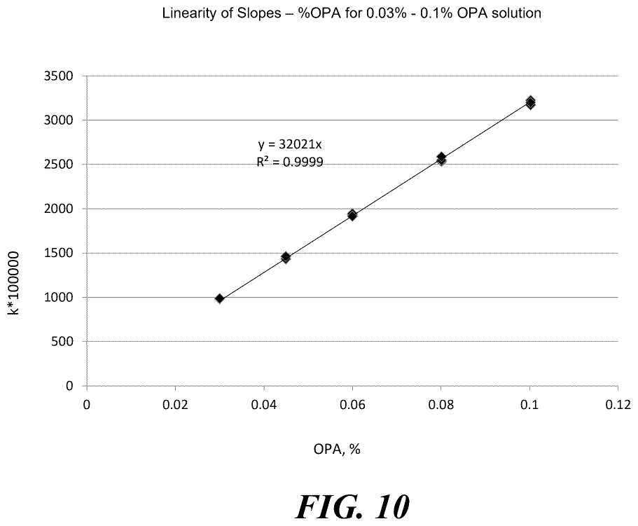

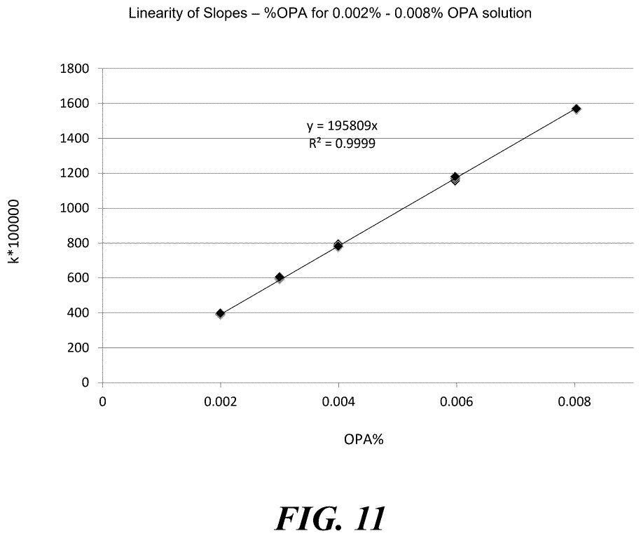

The results, summarized in Tables 8 and 9, and FIG. 10 and FIG. 11, respectively, show that the relative standard deviation (RSD) of triplicate measurements ranged between 0.29% and 1.12%. This indicates a high level of precision in the measurements. Furthermore, the linearity of the dilution series was confirmed with coefficient values of greater than 0.9992 when the curve was plotted with an intercept at the zero point. This high level of linearity demonstrates the effectiveness of the dilution method and the reliability of the spectrophotometric measurements in assessing the concentration-dependent changes in absorbance with temperature.

TABLE 8
Slope values (k × 10⁵) of 0.03-0.1% OPA Solutions (316 nm)

| OPA Level, % | Slope k*100000 | Average | RSD, % |
|---|---|---|---|
| 0.02999 | 987 | 985.33 | 0.29 |
| | 982 | | |
| | 987 | | |
| 0.04497 | 1434 | 1451.33 | 1.03 |
| | 1460 | | |
| | 1460 | | |
| 0.05997 | 1934 | 1931.67 | 0.44 |
| | 1946 | | |
| | 1915 | | |
| 0.08010 | 2532 | 2555 | 1.12 |
| | 2546 | | |
| | 2587 | | |
| 0.10022 | 3225 | 3197.67 | 0.86 |
| | 3170 | | |
| | 3198 | | |

The results for 0.002-0.008% solutions measured at 260 nm are summarized in Table 2. Relative standard deviation of triplicate measurements ranges from 0.17% to 1.11%. The linearity coefficient was 0.9997, and 0.9996 if the curve is set at intercept (crossing 0 point).

TABLE 9
Slope values (k × 10⁵) of 0.002-0.008% OPA Solutions (260 nm)

| OPA Level, % | Slope k*100000 | Average | RSD, % |
|---|---|---|---|
| 0.001993 | 393 | 393.33 | 0.89 |
| | 390 | | |
| | 397 | | |
| 0.002996 | 593 | 598.33 | 1.02 |
| | 597 | | |
| | 605 | | |
| 0.003992 | 777 | 784.33 | 1.11 |
| | 794 | | |
| | 782 | | |
| 0.005974 | 1156 | 1168.33 | 1.03 |
| | 1169 | | |
| | 1180 | | |
| 0.008030 | 1566 | 1567 | 0.17 |
| | 1565 | | |
| | 1570 | | |

The repeatability and linearity for OPA concentrations of 0.03%-0.1% and 0.002%-0.008% further confirm the applicability of the test method to measure a wide range of OPA concentrations.

1. A system for measuring a concentration of a chemical in a sample, the system comprising:
a spectrophotometric system comprising a light source, a sample cell for containing the sample, and a light detector;
a heating element for heating the sample cell;
a temperature probe; and
a processor configured to determine the concentration of the chemical by determining a slope of an absorbance-temperature curve of the sample and comparing the slope with a standard slope-concentration relationship of the chemical.

2. The system of claim 1, wherein the chemical has an absorbance that changes with temperature.

3. The system of claim 2, wherein the chemical is an aromatic compound.

4. The system of claim 1, wherein the chemical is selected from the group consisting of Ortho-phthalaldehyde (OPA), substituted or unsubstituted benzaldehydes, substituted or unsubstituted benzene, substituted or unsubstituted toluene, substituted or unsubstituted xylene, substituted or unsubstituted phenol, substituted or unsubstituted aniline, substituted or unsubstituted glucose, and a protein.

5. The system of claim 4, wherein the chemical is Ortho-phthalaldehyde (OPA).

6. The system of claim 5, wherein the system has an accuracy of plus/minus 0.1 w % for OPA concentrations near minimum efficacious concentration of approximately 0.3 w %.

7. (canceled)

8. (canceled)

9. The system of claim 1, wherein an absorbance is measured at a wavelength in a range of about 190 to about 1100 nm or about 300 nm to about 400 nm.

10. (canceled)

11. The system of claim 1, wherein an absorbance is measured at a wavelength greater than 800 nm.

12. The system of claim 1, wherein the temperature probe is a thermal couple or a spectroscopic probe of temperature.

13. (canceled)

14. The system of claim 1, wherein the heating element comprises an electrical heating element or a radio wave heating element.

15. The system of claim 1, wherein the heating element is not operably connected to the spectrophotometric system.

16. The system of claim 1, wherein the system further comprises a reservoir, wherein the sample is recycled to the reservoir during or after a measurement.

17. The system of claim 1, wherein the light detector comprises at least one of a photomultiplier tube (PMT) and a single channel light sensor.

18. The system of claim 1, wherein the system further comprises at least one of a filter for measuring circular dichroism and a filter for measuring polarization.

19. The system of claim 1, wherein the system is a portable device, that measures absorbance from a single channel light sensor.

20. An analytical method for measuring a concentration of a chemical in a sample, the method comprising the steps of:
measuring a first absorbance of the sample at a first temperature;
measuring a second absorbance of the sample at a second temperature;
determining a slope of absorbance-temperature relationship of the sample; and
determining a measured concentration of the chemical by correlating the measured slope with a standard slope-concentration curve for the chemical.

21. The method of claim 20, further comprising heating the sample to the first temperature and letting the sample cool to the second temperature.

22. The method of claim 20, wherein the standard slope-concentration curve for the chemical is provided by determining the absorbance-temperature relationship of a chemical standard at one or more known concentrations.

23. The method of claim 20, wherein the chemical is Ortho-phthalaldehyde (OPA).

24. The method of claim 23, wherein the method has an accuracy characterized as a recovery percentage (measured value vs real value) of greater than 60%.
